(19) United States
(12) Patent Application Publication
(10) Pub. No.: US 2014/0106040 A1
(43) Pub. Date: Apr. 17, 2014

(54) Antimicrobial Agent

(71) Applicant: Jeff Dodd, Clitheroe (GB)

(72) Inventor: Jeff Dodd, Clitheroe (GB)

(73) Assignee: NATURAL BIOTECHNOLOGY SPRL, Courcelles (BE)

(21) Appl. No.: 13/582,983

(22) PCT Filed: Mar. 4, 2011
(86) PCT No.: PCT/GB11/00313

§ 371 Date: Jul. 29, 2013

(30) Foreign Application Priority Data
Mar. 5, 2010 (GB) 1003758.8

(51) Int. Cl. A23B 7/10

(52) U.S. Cl. CPC A23B 7/10
USPC 426/335; 424/709

(57) ABSTRACT

There is described a method for the decontamination of (whole) fruit and/or vegetables comprising: (i) an optional first step of pre-washing the fruit and/or vegetables in high concentration of the decontaminant to deal with heavy spoilage; (ii) washing the fruit and/or vegetables in a low concentration of the decontaminant to deal with any residual microbial presence; wherein the decontaminant comprises an acidulant, such as sodium hydrogen sulphate, citric acid, lactic acid and tannic acid.

### FIELD OF THE INVENTION

The present invention relates to a novel composition and to novel methods related thereto.

More particularly, the invention relates a novel composition suitable for extending the storage life of fresh produce, such as fruit and vegetables. The use of the composition and the method of the invention prevents or mitigates the spoilage of such fresh produce.

### BACKGROUND OF THE INVENTION

Prior to processing either as whole/peeled or sliced fruit and vegetables need to be washed in a suitable medium as to decontaminate the fruit and vegetables of microorganisms that are deposited on the surface of fruit and vegetables derived from bird droppings or directly from the soil. Such microorganisms include E. coli, Salmonella, B. proteus, B.coli, B. subtilis, staphylococci, streptococci, sarcinae, yeasts, moulds and Gram Positive and Gram negative Bacilli. Whilst it is comforting to know than germs/bacteria present on the surface of fruit and vegetables do not penetrate through the unbroken fruit or vegetable skin it is essential to ensure fruit and vegetables are properly washed/decontaminated prior to being peeled and sliced. If not, cross contamination will occur from the protective skin covering to the edible pulp resulting in potential bouts of diarrhoea, colic, and vomiting.

There is an increased demand for prepared fruits and vegetables and therefore the prevention or mitigation of contamination of such prepared foods is especially important for the retailer of such produce. If the produce is contaminated resulting in food poisoning the legal consequences can be damaging as well as financially and affect a retailers credibility to supply fresh safe edible fruit and vegetables.

Pre-wash preparation of whole fruit and vegetables is essential to prevent the potential cross contamination of bacteria/pathogens once the fruit and/or vegetable has been peeled or sliced.

Conventionally, decontamination is controlled with chemicals, such as, chlorine, chlorine dioxide, quaternary ammonium halides, or by destroying with heat, i.e. thermal sterilisation. However, there are consumer and industry concerns about the use of chlorine products in treating foodstuffs and packaging.

### SUMMARY OF THE INVENTION

We have now developed a novel method for the decontamination of (whole) fruit and/or vegetables comprising:

(i) an optional first step of pre-washing the fruit and/or vegetables in high concentration of the decontaminant to deal with heavy spoilage;

(ii) washing the fruit and/or vegetables in a low concentration of the decontaminant to deal with any residual microbial presence;

wherein the decontaminant comprises an acidulant.

The decontamination of the whole fruit and/or vegetables may preferentially be carried out prior to packing (e.g. as in fruit) and/or peeling (e.g. as in vegetables) and/or slicing, (e.g. as in apples).

Preferentially, the process of the invention comprises the simultaneous treatment of produce (fruit and vegetables) with a decontaminant formulated using naturally derived intermediates formulated in such a way to maximise a quick effective and efficient decontamination process without adverse effects to the integrity of the treated fruits and vegetables. Thus, the decontaminant may be present in a solution and the produce may be dipped in the solution to achieve the desired effect.

According to this aspect of the invention the acidulant is selected from those that will reduce the pH to at least about 3 or less. In a preferred aspect of the invention the acidulant will reduce the pH to at least about 2.3 or less, preferably 2 or less, preferably to about 1.8 or less and most preferably to about 1.4 or less.

The amount of concentration of decontaminant present may vary depending upon, inter alia, the nature of the decontaminant, the level of spoilage/biofilm on the fruit and/ or vegetables being treated. However, the amount of decontaminant/acidulant, present may be from about from about 0.1% to about 25% (w/v), preferably from about 0.1% to about 6% (wlv), preferably from about 0.1% to about 4% (w/v), preferably from about 1% to about 4% (w/v).

In a preferred aspect of the study the acidulant is a modified acidified salt. The acidified salt may be acidified sodium chloride, e.g. bisulphate of soda/ sodium bisulphate/ sodium hydrogen sulphate (NaHSO₄). Preferably, the modified acidified salt may include an antioxidant/reducing agent, such as ascorbic acid. Desirably the antioxidant/reducing agent will be a free radical scavenger which can prevent oxidation by altering the REDOX potential of the system and can reduce undesirable oxidative products.

The acidulant may include one or more enzyme inhibitors. A variety of enzyme inhibitors may be utilised in the method of the invention, however, preferentially the enzyme inhibitor comprises a combined treatment of an acidulant and an antioxidant/ reducing agent. In the combined treatment according to this aspect of the invention may comprise the use separately, sequentially or simultaneously of an acidulant and an antioxidant/ reducing agent.

However, a variety of antioxidants/reducing agents may be used. Thus, specific antioxidants/reducing agents which may be mentioned include, but shall not be limited to, ascorbic acid (vitamin C) and especially salts thereof, such as alkali metal salts, e.g. sodium ascorbate; kojic acid (5-hydroxy-2-(hydroxymethyl)-4H-pyran-4-one) and salts thereof;

erythorbic acid and especially salts thereof, such as alkali metal salts, e.g. sodium erythorbate; phenolic antioxidant carboxylic acids, such as a rosmarinic acid ([[3-(3,4-dihydroxyphenyl)-1-oxo-2E-propenyl]oxy]-3,4-dihydroxy- benzenepropanoic acid) and optionally salts thereof, such as alkali metal salts. The aforementioned antioxidants/reducing agents, such as, ascorbic acid, act as a reducing agent which functions as a free radical scavenger preventing oxidation by altering the REDOX potential of the system and reduces undesirable oxidative products.

The amount of antioxidant/reducing agent, as hereinbefore described, may vary and may be from about 0.25% (w/v) to about 10% (wlv), preferably from about 0.5% (w/v) to about 5% (w/v), more preferably from about 1% (w/v) to about 2% (w/v).

According to one aspect of the invention we provide a method as hereinbefore described wherein the pre-wash/pre-dipping step is present.

According to an alternative aspect of the invention we provide a method as hereinbefore described wherein the pre-wash/pre-dipping step is absent.

The acidulant, e.g. sodium bisulphate or a combination of sodium bisulphate and an antioxidant/reducing agent, such as ascorbic acid, may be prepared in a diluent. Whilst a variety of diluents may be used, a preferred diluent comprises one or more of a flavouring and preservative agent, such as, citric acid, and optionally salts thereof, or succinic acid, and optionally salts thereof; a surfactant, such as, an alkyl (alkyl C1 to 20, preferably C8) glucoside; and a pH regulator, such as, lactic acid, and optionally salts thereof. Preferably, the diluent comprises a blend of two or more of a flavouring and preservative agent(s), a surfactant and a pH regulator. Most preferably the diluent comprises a blend of two or more of succinic acid, citric acid, an alkyl glucoside and lactic acid, and optionally salts thereof, and more preferably a blend comprising each of succinic acid, citric acid, an alkyl glucoside and lactic acid, and optionally salts thereof

The modified bisulphate of soda may function as an acidulant and thereby has a denaturing effect on microorganisms, for example, by reducing the pH to below the level at which is required to inactivate microorganisms.

Preferentially the decontaminant is one which can reduce or better “kill” those bacterium/micro-organisms common to fruit and vegetables, fish meat and poultry which are detrimental to health. Such a decontaminant will achieve a minimum Log Reduction of 5 against both Gram+ and Gram-organisms. The microbiological analysis will use the methodology as prescribed by ENBS 1276:1997, available from BSI in the UK.

The term “high concentration” when used in connection with the pre-washing according to the present invention would generally be understood by the person skilled in the art. However, a high concentration may be from about 2 to about 10% (w/v), preferably 2.5 to about 5% (w/v). The term “low concentration” when used in connection with the main wash according to the present invention would generally be understood by the person skilled in the art. However, a low concentration may be from about 0.1 to about 1.5% (w/v), preferably 0.5 to about 1% (w/v).

Therefore, according to a further aspect of the invention we provide a composition suitable for the decontamination of (whole) fruit and/or vegetables comprising an acidulant present in an amount from about from about 0.1% to about 25% (w/v).

According to this aspect of the invention the acidulant is a modified acidified salt as hereinbefore described. Preferably, the modified acidified salt in the composition of the invention may be a mixture of bisulphate of soda and an antioxidant/reducing agent, such as ascorbic acid.

However, a variety of antioxidants/reducing agents may be used. Thus, specific antioxidants/reducing agents which may be included in the composition of the invention, are one or more of ascorbic acid (vitamin C) and especially salts thereof, such as alkali metal salts, e.g. sodium ascorbate; kojic acid (5-hydroxy-2-(hydroxymethyl)-4H-pyran-4-one), and salts thereof; erythorbic acid and especially salts thereof, such as alkali metal salts, e.g. sodium erythorbate; phenolic antioxidant carboxylic acids, such as a rosmarinic acid ([[3-(3,4-dihydroxyphenyl)-1-oxo-2E-propenyl]oxy]-3,-dihydroxy- benzenepropanoic acid) and optionally salts thereof, such as alkali metal salts.

In the composition of the invention the antioxidant/reducing agent, such as ascorbic acid, may comprise a diluent. Whilst a variety of diluents may be used, a preferred diluent comprises one or more of a flavouring and preservative agent, such as, citric acid, and optionally salts thereof, or succinic acid, and optionally salts thereof; a surfactant, such as, an alkyl (alkyl Cl to 20 preferably C8) glucoside; and a pH regulator, such as, lactic acid, and optionally salts thereof. Preferably, the diluent comprises a blend of two or more of a flavouring and preservative agent, a surfactant and a pH regulator. Most preferably the diluent comprises a blend of two or more of succinic acid, citric acid, an alkyl glucoside and lactic acid, and optionally salts thereof, and more preferably a blend comprising each of succinic acid, citric acid, an alkyl glucoside and lactic acid, and optionally salts thereof.

According to a yet further aspect of the invention we provide a kit suitable for the decontamination of (whole) fruit and/or vegetables, the kit comprising:
(i) an optional pre-dipping component as hereinbefore described; and
(ii) a low concentration decontaminant as hereinbefore described.

According to one aspect of the invention we provide a kit as hereinbefore described in which the pre-dipping component is present.

According to an alternative aspect of the invention we provide a kit as hereinbefore described in which the pre-dipping component is absent.

In the composition or kit as herein before described, the optional pre-wash/dipping component may comprise a chelating agent. Thus, as hereinbefore described the chelating agent should have an affinity to copper or iron and salts thereof. It will be understood that more than one chelating agent may be present, for example, a copper selective chelating agent may be combined with an iron selective chelating agent. The chelating agent may also be an agent, e.g. an acidulant, which may reduce the pH of the environment, such as, an organic acid selected from one or more of citric acid, lactic acid, succinic acid or tannic acid or a combination thereof, and optionally salts thereof.

In the kit of the present invention as herein before described the chelating agent e.g. in a single composition or solution, or separate.

In the composition or kit as hereinbefore described, the decontaminant may comprise a combined treatment of an acidulant and an antioxidant/ reducing agent. In such a decontaminant combination, i.e. acidulant and an antioxidant/ reducing agent, the acidulant may desirably be a modified acidified salt, such as bisulphate of soda as hereinbefore described. Therefore, the acidulant is selected from those that will reduce the pH to at least about 3 or less. In a preferred aspect of the invention the acidulant will reduce the pH to at least about 2.3 or less, preferably 2 or less, preferably to about 1.8 or less and most preferably to about 1.4 or less.

In the composition or kit as hereinbefore described, the antioxidant/ reducing agent may preferentially be one or more of ascorbic acid (vitamin C) and especially salts thereof, such as alkali metal salts, e.g. sodium ascorbate; kojic acid (5-hydroxy-2-(hydroxymethyl)-4H-pyran-4-one), and salts thereof; erythorbic acid and especially salts thereof, such as alkali metal salts, e.g. sodium erythorbate; phenolic antioxidant carboxylic acids, such as a rosmarinic acid ([[3-(3,4-dihydroxyphenyl)-1-oxo-2E-propenyl] oxy]-3,4-dihydroxy-benzenepropanoic acid) and optionally salts thereof, such as alkali metal salts.

The present invention relates to decontamination formulations for disinfection and sterilization applications. In particular, the present invention is directed to aqueous formulations that include at least one reactive compound, bleaching activator, and inorganic base; and that allow the formulation to be pre-mixed and packaged as a one or two-part kit system. The decontamination composition can be delivered in a wide variety of embodiments, including, but not limited to, foams, sprays, liquids, gels, fogs, aerosols, etc.

In one aspect a method, composition or kit of the present invention comprises an amount of bisulphate of soda from about 1.25% to about 25% (w/v). In one aspect a method, composition or kit of the present invention comprises an amount of citric acid from about 0.1% to about 5% (w/v). In one aspect a method, composition or kit of the present invention an amount of lactic acid may be from about 0.4% to about 20% (w/v). In one aspect a method, composition or kit of the present invention an amount of alkyl (preferably C8) glucoside may be from about 0.2% to about 10% (w/v). In one aspect a method, composition or kit of the present invention an amount of tannic acid may be from about 0.1% to about 15% (w/v). In a preferred aspect of the present invention a method, composition or kit of the present invention comprises an amount of citric acid from about 0.1% to about 5% (w/v), an amount of lactic acid from about 0.4% to about 20% (w/v), an amount of alkyl (preferably C8) glucoside from about 0.2% to about 10% (w/v), and an amount of tannic acid from about 0.1% to about 15% (w/v).

The decontamination as hereinbefore described may comprise the removal, elimination, mitigation of prevention of one or more of bacteria, fungi, yeasts and viruses. The decontamination is particularly useful against gram-positive bacteria, which shall include, but shall not be limited to, Staphylococci, such as, S. aureus; Streptococci, such as, S. pyogenes, S. agalactiae, S. pneumonia, etc.; Enterococci, such as, E. faecalis; Corynebacteria, such as, C. diphtheriae; Clostridia, such as, C. botulinum; and Listeria, such as, L. monocytogenes; or the decontamination of gram-negative bacteria which shall include, but shall not be limited to, Escherichia coli, Salmonella and Shigella.

The invention will now be illustrated by way of example only.

### EXAMPLE 1

Decontamination of Fruit (Apples, Pears, Plums, Mangos, Bananas, Melons, Guava, Pine apple, Grapes and berries (Strawberries, Raspberries)

This study is focussed on:
1. The Decontamination of Fruit (identified above) using a single phase treatment with the decontamination formulation as described.
2. Commercially feasible, cost effective as a preservative and by extending the shelf life of the produce.
3. Minimising the need to modify in-house processing plant and equipment.

The study takes into account the relevance and importance of retaining by minimising loss of:

1. Natural flavour

2. Colour

3. Texture

4. Overall appearance

5. Cost effectiveness

EXAMPLE 2

Formulation (NATRApHASE™ FVS

Formulation can be (w/v):

Bisulphate of soda: 1.25% -25%

Citric Acid: 0.1% -5%

Lactic Acid: 0.4% -20%

C8 Alkyl Glucoside: 0.2% -10%

Tannic Acid: 0.1% -15%

### EXAMPLE 3

The micro results we achieved are as shown

Microbiological Analysis

F. A. O.: The Quality Manager

En 1276:1997 Test Certificate

Test Substance: NAT RApHASE™ FVS Concentration:2% v/v

Contact time: 5 minutes

Conditions: Clean 22′c

Date: 06/05/2009

Lab Reference: NATRApHASE™ FVS

| | Challenge | | Log | Pass/ |
|---|---|---|---|---|
| Culture | cfu/ml | Percent Kill | Kill | Fail |
| Pseudomonas Aeruginosa | 3.9E+07 | >99.999 | >7.5 | Pass |
| ATCC 15442 | | | | |
| Escherichia coli ATCC 10536 | 3.4E+07 | >99.999 | >7.5 | Pass |
| Staphylococcus aureus ATCC | 2.9E+07 | 100.000 | 5.4 | Pass |
| 6538 | | | | |
| Enterococcus hirae ATCC | 3.8E+07 | 100.000 | 5.6 | Pass |
| 10541 | | | | |
| Salmonella typhimurium | 3.4E+07 | >99.999 | >7.5 | Pass |
| ATCC 13311 | | | | |
| Listeria monocytogenes (Lab | 2.3E+07 | 100.000 | 6.0 | Pass |
| Strain) | | | | |
| Bacillus cereus NCIMB 11925 | 3.0E+07 | 99.994 | 6.4 | Pass |
| Candida Albicans NCYC 1363 | 3.1E+07 | 100.000 | 6.0 | Pass |
| Clostridium perfringens | 3.1E+7 | 100 | >7.5 | Pass |
| Aspergillus niger IMI 104215 | 3.1E+07 | 99.999 | 6.0 | Pass |

1. A method for the decontamination of (whole) fruit and/or vegetables comprising:
(i) an optional first step of pre-washing the fruit and/or vegetables in high concentration of the decontaminant to deal with heavy spoilage;
(ii) washing the fruit and/or vegetables in a low concentration of the decontaminant to deal with any residual microbial presence;
wherein the decontaminant comprises an acidulant.

2. A method according to claim 1 wherein the decontamination of the (whole) fruit and/or vegetables is carried out prior to packing (e.g. as in fruit) and/or peeling (e.g. as in vegetables) and/or slicing, (e.g. as in apples).

3. A method according to claim 1 wherein the acidulant is selected from those that will reduce the pH to at least about 3 or less.

4. A method according to claim 1 wherein the concentration of decontaminant is from about from about 0.1% to about 25% (w/v).

5. A method according to claim 1 wherein the acidulant is a modified acidified salt.

6. A method according to claim 1 wherein the acidulant is sodium hydrogen sulphate (NaHSO₄).

7. A method according to claim 1 wherein the acidulant includes one or more antioxidants/reducing agents.

8. A method according to claim 1 wherein the antioxidant/reducing agent is selected from one or more of ascorbic acid, and salts thereof; kojic acid, and salts thereof; erythorbic acid, and salts thereof; and a phenolic antioxidant carboxylic acid, such as a rosmarinic acid, and salts thereof.

9. A method according to claim 1 wherein the acidulant includes one or more enzyme inhibitors.

10. A method according to claim 1 wherein the antioxidant/reducing agent is present in an amount of from about 0.25% (w/v) to about 10% (w/v).

11-12. (canceled)

13. A method according to claim 1 wherein the antioxidant/reducing is prepared in a diluent selected from one or more of a flavouring and preservative agent(s); a surfactant; and a pH regulator.

14-16. (canceled)

17. A method according to claim 1 wherein the surfactant is an alkyl (alkyl Cl to 20) glucoside.

18. (canceled)

19. A composition suitable for the decontamination of (whole) fruit and/or vegetables comprising an acidulant present in an amount from about from about 0.1% to about 25% (w/v).

20. A composition according to claim 19 wherein the acidulant is a modified acidified salt.

21. A composition according to claim 19 wherein the acidulant is sodium hydrogen sulphate (NaHSO₄).

22. A composition according to claim 19 wherein the acidulant includes one or more antioxidants/reducing agents.

23. A composition according to claim 19 wherein the antioxidant/reducing agent is selected from one or more of ascorbic acid, and salts thereof; kojic acid, and salts thereof; erythorbic acid, and salts thereof; phenolic antioxidant carboxylic acids, such as a rosmarinic acid, and salts thereof.

24. A composition according to claim 19 wherein the antioxidant/reducing agent is present in an amount of from about 0.25% (w/v) to about 10% (w/v).

25. A composition according to claim 19 wherein the optional pre-wash component includes a chelating agent.

26. A composition according to claim 19 wherein the optional pre-wash component includes a chelating agent and the chelating agent is an acidulant.

27. A composition according to claim 19 wherein the chelating agent acidulant is an organic acid selected from one or more of citric acid, lactic acid, succinic acid or tannic acid or a combination thereof, and optionally salts thereof.

28-32. (canceled)
